(19) United States
(12) Patent Application Publication
(10) Pub. No.: US 2015/0059597 A1
(43) Pub. Date: Mar. 5, 2015

(54) Slow and Citrus Juicer Combination

(71) Applicant: E. MISHAN & SONS, INC., NEW YORK, NY (US)

(72) Inventor: Stuart Harvey Lee, Forest Hills, NY (US)

(73) Assignee: E. MISHAN & SONS, INC., New York, NY (US)

(21) Appl. No.: 14/015,465

(22) Filed: Aug. 30, 2013

(51) Int. Cl. A23N 1/00

(52) U.S. Cl. CPC A23N 1/003
USPC 99/513

(57) ABSTRACT

A juicer with interchangeable modules such as a citrus juicer module and a slow juicing module allowing convenient use of different juicer modules with a single base unit. A base houses a motor and a protruding drive shaft. Arms protruding from the sides of the base have hooked ends for holding the modules above. The arms can be freed to pivot when snapped out of a notch, or fixed in an upwards position holding a module when snapped into a notch. A citrus juicer module has a pitcher-like juice collector, a strainer, and a citrus juicing member. The strainer includes two locking surfaces which are formed to compliment the hooks of the arms for holding and quickly releasing the citrus juice module. An interchangeable slow juicer module can be provided as an alternative to the citrus juicer module.

### FIELD AND BACKGROUND OF THE INVENTION

The present invention relates generally to the field of kitchen appliances, and in particular to fruit and vegetable juicers including citrus fruit juicers and “slow” juicers.

A juicer is a tool for separating juice from fruits, herbs, leafy greens, and other types of vegetables from pulp and solids in a process called “juicing”. By separating juice and liquid from pulp, juicers can be used to concentrate the nutrition naturally present in fruits and vegetables. The use of juicers can make it easier to consume more fruits and vegetables than would be practical or enjoyable if only whole solid produce is consumed. Juicers also allow novel flavor combinations that would be difficult or impossible to achieve without juicing.

A variety of juicers and methods are known in the art for extracting juice from food, typically from fruits and vegetables.

A centrifugal juicer typically cuts up the fruit or vegetable with a flat cutting blade. It then spins the produce at a high speed to separate the juice from the pulp using centrifugal forces.

A masticating juicer typically uses a single auger to compact and crush produce into smaller pieces before squeezing the juice out through a static screen, while the pulp is expelled through a separate outlet. Triturating juicers have twin augers to crush and press produce.

A “slow juicer” is a juicing device that uses lower speeds and energies than conventional juicers to extract juices. Slow juicers work by masticating and pressing, typically using a screw-like auger in a manner analogous to a mortar and pestle. The action crushes and presses the food, releasing juices. A slow juicer might operate at only 80 RPM and use approximately 150 Watts of energy, as opposed to 1,000-24,000 RPM and up to 1,500 Watts of energy which a traditional centrifugal “high speed” juicer might use. This is a relatively new technology which has become popular with consumers, and it is believed to create more nutritious and better tasting juice than many traditional juicers. The Hurom™ Slow Juicer by Roland Products, Inc. is one exemplary model.

Different techniques and machines are preferred, however, for removing juice from citrus fruit, such as oranges, grapefruits, lemons and limes, than from other types of produce. Citrus fruits are distinct in having thick inedible rinds on the outside, and extremely juicy insides. The rinds often have strong flavors and smells which are desirable in select applications (lemon rind is a popular seasoning because of its strong fragrance) but which can create undesirable bitter flavors in other applications, particularly juice. The rind is also thick and tough with lower liquid content. As a result, it is often preferable and more efficient to extract citrus juice in a way that extracts the juice from the juicy inside of the fruit but avoids including rind or any material or liquid from the rind in final juice product. Standard juicers, such as those mentioned above, which crush all of the produce material they are fed are therefore not preferred for citrus fruit.

Reamers are often used for extracting juice from citrus fruits such as grapefruits, lemons, limes, and oranges. Juice is extracted by pressing or grinding a halved fruit along a juicer's ridged domed center and discarding the rind. Some reamers are stationary and require a user to press and turn the fruit, while others are electrical, automatically turning the ridged center which the rind-free side of the cut fruit is pressed into to extract juice.

An electric citrus reamer juicer juices citrus more quickly and with less effort than a manual reamer because it uses an electric motor to spin the reamer. An electric citrus reamer is therefore advantageous for making larger amounts of citrus juice, for getting more juice from each fruit, and for juicing multiple oranges or other citrus fruits quickly and easily.

A drawback to conventional citrus juicers, both manual and electric, is that they are not suitable for juicing most other vegetables and non-citrus fruit. As a result, multiple devices may be required, or a user may have to either not use citrus or confine themselves to only using citrus. Multiple devices can be expensive and can take up excess counter and storage space in a home kitchen. As a result, juicers which can combine the advantages of electric citrus juicers with other juicers, such as slow juicers, are desirable.

U.S. Pat. No. 4,240,338 describes a citrus juicer attachment for a food processor. The food processor includes a citrus fruit juice extraction unit, and an attachment for extraction of juice from citrus fruit. The attachment consists of an annular trough-like member fitting within the cylindrical food processing container mounted on the base of the food processor. The trough-like member has apertures in the bottom to permit the passage of citrus fruit juice while restraining passage of pulp and pips associated with the juice. The annular trough-like member has a circumferential flange which rests on the upper edge of the container and supports the trough-like member. Juice collects in the space where food processing normally take place.

U.S. Pat. Nos. 5,193,447 and 5,445,069 disclose a citrus juicer with means for adjusting the pulp content. The motor-driven cone is surrounded on all sides by a strainer having passageways to a bowl for collecting the fruit juice. As a citrus fruit is squeezed, the juice passes through the passageways of the strainer. The boundary area between the cone and the area of the strainer surrounding it is an annular gap whose cross section of passage is increased or decreased to control the pulp content in the fruit juice.

U.S. Pat. No. 6,860,196 is a citrus juicer driven by an electric motor. The rotation of a reaming element is activated by pressing the fruit down on the element, which presses a drive shaft against a switching means activating the electric motor.

International publication WO 2013/020179 describes a juicer and a blender hybrid sharing a common base and a common motor. The juicer has a spout that discharges into the blender.

### SUMMARY OF THE INVENTION

It is an object of the present invention to provide an improved citrus fruit juicer. It also provides a system of modular attachments having locking surfaces for use with a single motorized base, and having locking arms which are complimentary to all of the locking surfaces on various modules to allow fast and easy interchangeability. A particularly attractive aspect of the system is that the same set of locking arms can accommodate modules having different diameters by using locking surfaces at varied angles. A system with interchangeable citrus juicer and slow juicer attachments, and a citrus juice extracting attachment for use with a motorized base are also provided. The invention also includes a system and method of fixing and releasing juicer modules using a single shared base using locking arms, hooks, angled locking surfaces, notches, pivoting locking members, snapping locking arms into notches, prongs inserted into slots and contacting activation surfaces which render the motor operational, and the other elements described in greater detail below.

Accordingly, in one aspect of the invention, a juicer with a removable citrus juice module for extracting juice from citrus fruits comprises a base containing a driving motor and a means for controlling the motor.

The base has a handle for holding and carrying the juicer, and a plurality of elongated locking arms projecting from opposite sides of the base. Each locking arm has a pivoting end near the base and an opposite distal end for holding modules. Each locking arm may have two parallel longitudinal ribs on an inner side of the locking arm facing the base and tracing the perimeter of the arm. Each locking arm also comprises a hook at its distal end, each hook optionally being a short end portion of an elongated locking arm which is bent approximately 90° with regard to the adjoining section of the arm inward towards the juicer. The longitudinal ribs continue into the hook and, at an extreme distal end of the locking arm, diverge from their parallel orientation towards each other to meet at the extreme distal end of the arm to form a locking rim at the end of the arm. The ribs and the locking rim form a concave locking cavity under each hook. Each arm can include one, two, or more prongs or protuberances on an inner side, typically at the end of the arm which is linked to the base.

A pivoting end of each locking arm can be pivotally attached to a locking member, optionally between a pair of prongs on the arm, the locking member being in turn pivotally attached to the base. Each pivoting end and pivot member pairing can collectively snap into and out of a notch in the base to respectively fix in place or release each locking arm quickly and easily. Each notch may have one, two, or more slots shaped to each receive a prong or other protuberance. An activation surface can be provided within the base adjacent to at least one body slot in each notch. The slot may be an opening through the thickness of the body of the base, and is not limited to any specific shape.

A rotatable drive shaft projects upwards from a top surface of the base. The drive shaft is coupled to the motor inside the base and rotatable by the motor. Controls and electronics are provided to control the motor. Controls may include buttons, knobs, switches, and other known means.

The citrus juice module comprises a juice collector, a strainer, and a juicing member, the citrus juice module being removably seated above the base for extracting and collecting citrus juice. These elements may be provided in unitary form, or each as separate or separable parts.

The preferably annular juice collector is removably seated above the base, the juice collector being generally in the form of a small pitcher having a floor, circumferential side walls, a lip at the top of the side walls, an open top, a juice collector handle, a spout at the lip for pouring juice, and a juice collection area bounded by the floor and the side walls for collecting juice falling into the juice collector. The radius of the juice collector generally increases moving from the narrower floor to the wider lip at the top of the side walls.

The juice collector preferably has an axial sleeve projecting upwards from the center of the floor. The sleeve may be hollow, and separates the surrounding juice collection area from the area at the inside of the sleeve. The drive shaft may project into a lower portion of the sleeve when the juice collector is seated on the base. In other embodiments the drive shaft may project further into the sleeve, or not at all.

The strainer is preferably seated on the lip of the juice collector and above the juice collection area. The preferred strainer is annular and comprises a strainer floor with a plurality of apertures spaced around the strainer floor for passing citrus fruit juice while restraining the passage of seeds and pulp. A circular opening may be in the center of the floor. A circumferential strainer wall may surround the strainer floor and be positioned to block fruit material from laterally leaving the strainer.

One or more locking surfaces, most preferably two, are preferably at the top of the strainer wall at opposite sides of the strainer, each for releasably engaging a hook at an end of a locking arm. Each preferred locking surface has an inner wall and two side walls shaped to be complimentary to the end of the hooks, and an open side facing radially outwards for receiving a hook. Each locking surface has a floor and a laterally elongated locking projection protruding from the floor. The locking projections are shaped to fit inside of a locking cavity under a hook. When required to compliment the orientation of the hooks, the floors of the locking surfaces may slope at an angle downwards as they move radially outwards towards the open side.

The citrus juicing member is provided for reaming citrus fruits, and may be a standard citrus reamer shape. The member is rotatable, having ribs, and having a generally domed shape. The juicing member is removably positioned in the center of the strainer, and is at least one of within or above the circular opening in the strainer floor, and directly above the drive shaft. The juicing member is driveably engaged to the drive shaft by a drive adapter which is removably engaged to the drive shaft at one end and to a bottom of the citrus juicing member at an opposite end. The drive adapter may be at least partially within the sleeve of the juice collector, spanning a distance between the drive shaft and the juicing member. Rotation of the drive shaft causes rotation of the drive adapter and of the juicing member for removing juice from a halved citrus fruit. The drive adapter may include male or female surfaces at either end to engage complimentary male or female surfaces of the drive shaft and/or the juicing member.

The juicer has a locked citrus juicer state and an unlocked state. In the locked citrus juicer state, the two locking arms hold the citrus juice module in place on the base for extracting citrus juice. Both locking arms are snapped into their respective notches in the base, thereby fixing the locking arms in place in a configuration exerting continuous downward pressure on the citrus juicer module through the hooks. The hooks fix the citrus juice module on the base, the locked locking arms projecting generally upwards and optionally radially outwards as well depending on the size and shape of the module. The hook of each locking arm is engaged to one of the two locking surfaces on the strainer. The locking projection of each locking surface is inside of a concave locking cavity under the corresponding locking arm hook, and the motor is in an operable state. In the locked citrus juicer state one or more prongs of the locking arms can be positioned in the body slots within each notch. Preferably at least one prong is contacting an activation surface adjacent to each notch which allows operation of the motor.

In the alternative unlocked state, at least one locking arm is unlocked, or all locking arms are unlocked. The unlocked arm(s) are snapped out of their respective notches in the body, the unlocked arms are disengaged from the locking surfaces, and from the locking projections of the strainer. The locking arms are free to pivot outwards with respect to the body, and the locking arms do not hold the citrus juice module in place. The citrus juice module, or any module which is present, can be freely lifted off of the base in the unlocked state, and the motor is in an inoperable state, optionally because of a kill switch. In a preferred embodiment one or more activation surfaces are not contacted, and resiliently return to a resting position near a slot, in the inoperable state. When one or more activation surfaces are not contacted the motor may be prevented from running.

Another aspect of the invention is the ability to interchange modules quickly and easily using the system of locking arms and strategically positioned locking surfaces, the locking surfaces on various modules all complementing and being compatible with the locking arms on the shared base.

In a preferred embodiment a slow juicer module is provided which is interchangeable with the citrus juice module with respect to the base and the drive shaft. The juicer is adapted so that the citrus juice module and drive adapter can be removed from the base when the juicer is in the unlocked state. A slow juicer module is similarly adapted to be positioned on top of the base and in drivable engagement with the drive shaft in place of the citrus module as show in FIG. 13.

A top portion of the preferred slow juicer module optionally has a smaller radius than the strainer of the citrus juice module. A top portion of the slow juicer module has two opposite locking surfaces which are closer together than the preferred locking surfaces of the citrus juice module, and which have floors which are closer to horizontal than the angled locking surface floors of the citrus juice module, but which preferably are otherwise substantially the same as the locking surfaces of the citrus juice module for interchangeability.

In a locked slow juicing state, the two locking arms hold the slow juicer module in place on the base and in engagement with the drive shaft for extracting juice by slow juicing. Both locking arms are snapped into their respective notches in the base to fix the locking arms in place. The locked locking arms project generally upwards at an angle closer to vertical than the locked locking arms in the locked citrus juicer state. The hook of each locking arm is engaged to one of the locking surfaces on the slow juicing module. The locking projection of each locking surface of the slow juicing module is inside of the concave locking cavity under the corresponding locking arm hook. The motor is in an operable state when the juicer is in a locked configuration regardless of the specific module being used. FIG. 13 shows a juicer in a locked slow juicing state, although only one locking arm is visible.

In another aspect of the invention, a juicer with a removable citrus juice module has one, two, or more locking arms. One or more locking arms comprises one, two, or more prongs, preferably projecting from an inner side of the locking arm facing the base at the pivoting end of the arm. Locking members may be pivotally fixed to an arm between a pair of prongs. Each notch can include one, two, or more openings into the inside of the base, which may be body slots. The openings may be slots shaped to receive prongs.

Preferably at least one activation surface is provided near a body slot in a notch, the activation surface being positioned so that a prong received in the nearest body slot will contact the activation surface. Preferably the driving motor is only in an operable state when at least one activation surface, and preferably two out of two or more activation surfaces, are contacted by a prong or other protuberance when the arms are in a locked state. In the locked citrus juicer state and in the locked slow juicing state, at least one prong is positioned through a body slot, projecting into the interior of the body, and contacting and displacing an activation surface, and the motor is in an operable state. In the unlocked state, at least one activation surface is not contacted by any prong, and the motor is in an inoperable state.

The various features of novelty which characterize the invention are pointed out with particularity in the claims annexed to and forming a part of this disclosure. The above summary describes certain preferred aspects of the invention which may be used alone or in combination. For a better understanding of the invention, its operating advantages and specific objects attained by its uses, reference is made to the accompanying drawings and descriptive matter in which a preferred embodiment of the invention is illustrated.

### BRIEF DESCRIPTION OF THE DRAWINGS

In the drawings:

FIG. 1 is a side elevational view of a juicer with removable citrus juice module in a locked citrus juicer state;

FIG. 2 is a top plan view of the juicer in a locked citrus juicer state showing a strainer held by two hooks, and also showing a domed juicing member;

FIG. 3 is a top, side perspective view of a juice collector having an axial sleeve at its center;

FIG. 4 is a plan view of a strainer including two opposing locking surfaces;

FIG. 5 is a top plan view of a ribbed juicing member;

FIG. 6 is a top, front, left perspective view of a juicer with part of a slow juicer module in an unlocked state;

FIG. 7 is a side view of an adapter for transferring rotational motion from a drive shaft to a juicing member;

FIG. 8 is a side elevational view of a juicer base with a citrus juice module juice collector and a drive adapter;

FIG. 9 is a top, front, right perspective view of a lid for use in a slow juicer module;

FIG. 10 is a top front perspective view of an auger for use in a slow juicer module; and

FIG. 11 is a front elevational view of a base and drive shaft without any module in place.

FIGS. 12a-12c depict three different modules having different radii fixed to the same base using the same pair of arms in different orientations;

FIG. 13 is a side perspective view of a juicer with a removable slow juicer module in place in a locked slow juicing state.

### DESCRIPTION OF THE PREFERRED EMBODIMENTS

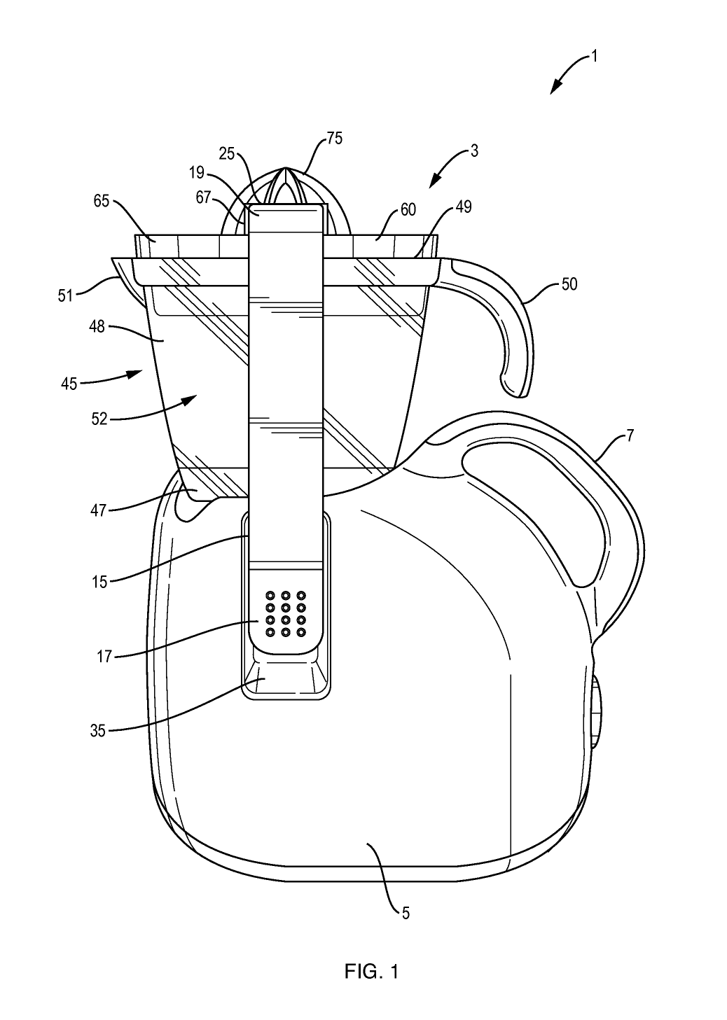

Referring now to the drawings, in which like reference numerals are used to refer to the same or similar elements, FIG. 1 shows an embodiment of the interchangeable module juicer system of the present invention. This depicted preferred embodiment includes a citrus juice module 3. The configuration in FIG. 1 is in a locked citrus juicer state where arms 15 hold the citrus juicer module 3 in place on the base, and the unit is ready for use with citrus fruit.

The preferred juicer 1 has a removable citrus juice module 3 for extracting juice from citrus fruits. The juicer includes a base 5 containing a driving motor and a means for controlling the motor. The invention is not limited to any particular type of motor. The control means may be a switch, dial, buttons, or any known means. The base typically houses the electrical and electronic components such as the power supply, control mechanisms, and electronics for turning the motor on and off. The base preferably has a handle which may be the generally C-shaped base handle 7 shown in FIG. 1. The handle is for holding and carrying the juicer, and may be integral with the base.

Elongated locking arms 15 project from opposite sides of the base 5. In the depicted preferred embodiment two arms are used, although one, three, or four arms are also possible. The arms are used to hold modules in place on top of the base, but can also be quickly released to release the module for removing or switching modules, and for pouring out juice. It is important and difficult to provide a strong connection between the base and the juicer modules because the action of the juicer creates a lot of movement and vibration. The juicer module must be held down in engagement with the drive shaft while the motor runs and fruit is being processed to function efficiently. The locking arms 15, described in greater detail below, are a key feature of the invention because they combine fixing strength with the ability to quickly and easily lock down and release a variety of different juicer modules, including modules of different shapes and sizes. The arms also provide an attractive and distinctive appearance.

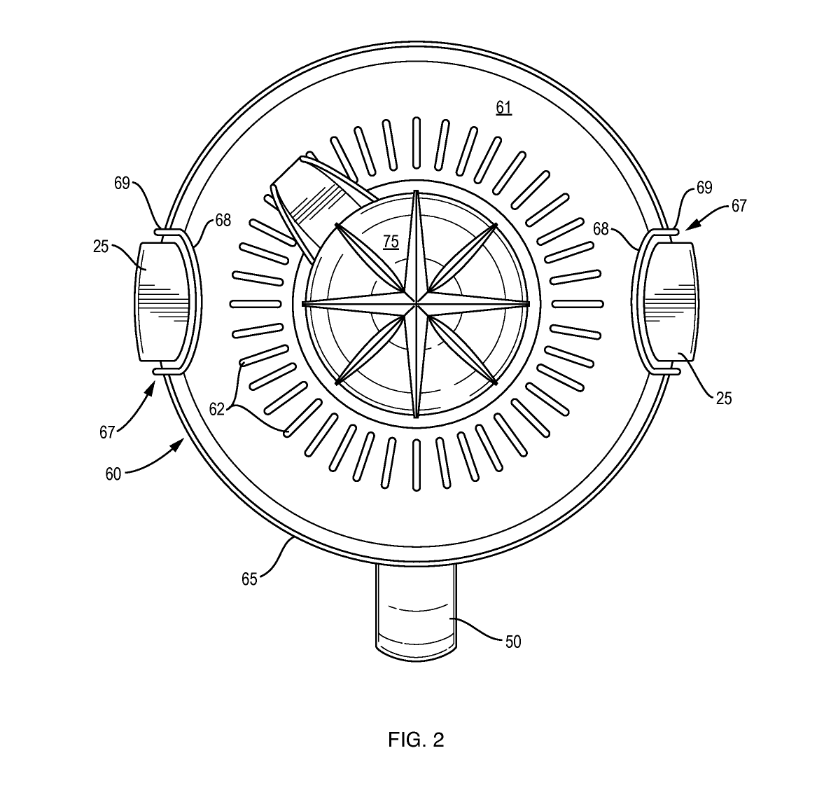

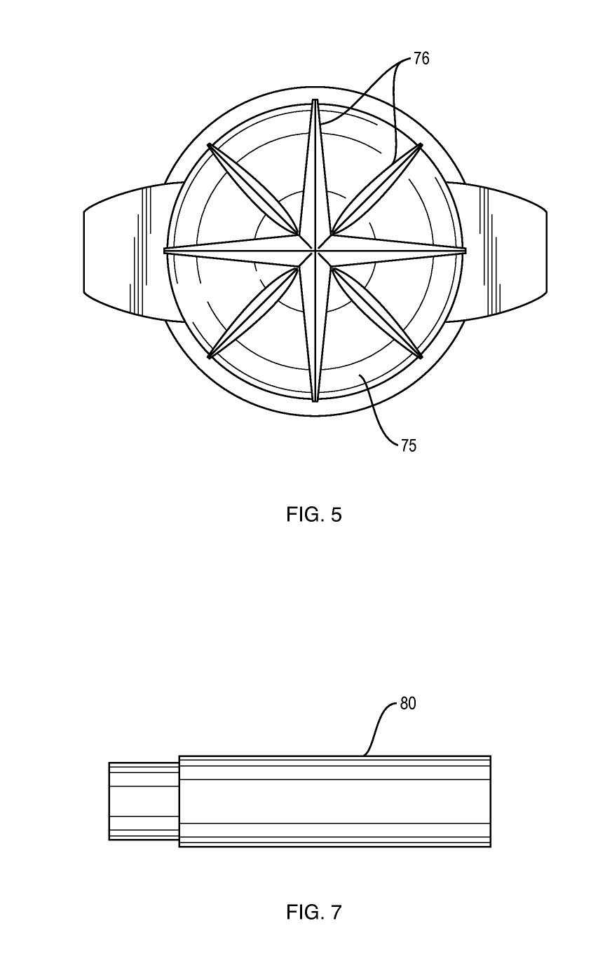

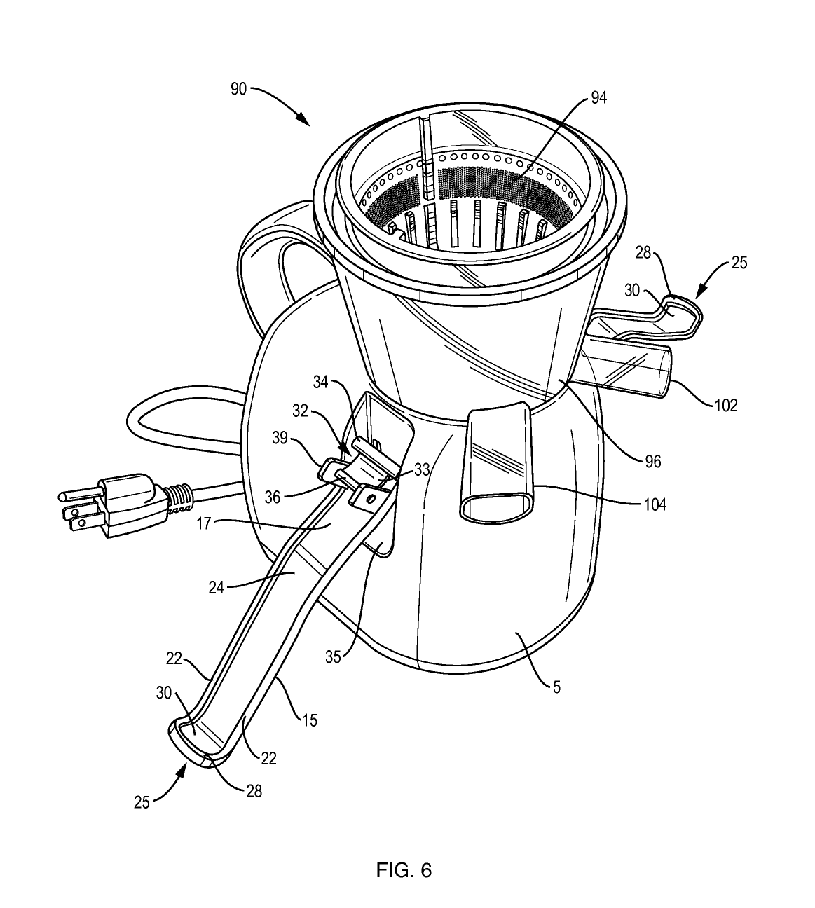

In the preferred embodiment in FIG. 6, each locking arm 15 has a pivoting end 17 nearer the base which can pivot up and down through an arc, and which can be locked into place when the juicer is in operation. FIG. 6 shows a base with part of a slow juicer module in place. FIGS. 1-2 show juicers with arms 15 locked in a generally upward position, holding a citrus juicer module in this example, and FIG. 6 shows a juicer where the arms 15 are unlocked and down. The opposite distal end 19 of the locking arms are for selectively engaging and holding modules on top of the base. The distal end of the arms can have a variety of configurations for engaging modules, and are not limited to the preferred embodiment using hooks 25 described below.

As shown in FIG. 6, each locking arm 15 can include two parallel longitudinal ribs 22 on an inner side 24 of the locking arm which face the base when the arms are in a locked, generally upwards position. In the depicted embodiment the ribs trace the perimeter of the arm 15.

Each locking arm preferably comprises a hook 25 at its distal end. The hook is typically a short end portion of an elongated locking arm 15 which is bent approximately 90° inwards with regard to the direction of the other longer parts of the arm. FIG. 2 shows a view from above of two opposite hooks 25 holding down a strainer 60 of a citrus juice module. The hooks bend inwards towards the axis of the device. The hooks are not limited to any particular shape, and may be bent more or less than 90°, may be larger or smaller, and may take various shapes as necessary to accommodate different arrangements, modules, and locking surfaces 67.

Referring back to FIG. 6, the longitudinal ribs 22 on the arms 15 continue into the hook 25 and, at an extreme distal end of the locking arm, diverge from their generally parallel orientation towards each other to meet at the extreme distal end of the arm to form a locking rim 28 at the end 19 of the arm 15 wherein the ribs and the locking rim form a concave locking cavity 30 under each hook 25. Locking cavities can also be provided using structures other than ribs 22 and locking rims 28, and can take a variety of shapes to accommodate and engage different locking surfaces 67 and/or locking projections 72. Providing a cavity under each hook which fits over a protrusion gives the hooks a stronger grip on the module the hook is holding, and prevents the arms from slipping radially outwards off of the locking surfaces when the arms are under tension in the locked state.

The opposite pivoting ends 17 of the arms are closer to or attached directly to the base below. Preferably the arms have an unlocked state where they have freedom to pivot or rotate towards and away from the body of the juicer (see FIG. 6), and a locked state where they are fixed projecting generally upwards to hold onto a module above using hooks, as shown in FIG. 1. Preferably the arms and hooks provide tension holding down the module above in the locked state. The arms are preferably generally elongated, but may be bowed or otherwise not perfectly straight as shown in FIG. 6. The length and shape of the arms can be varied to accommodate different modules. In some embodiments the arms will be somewhat flexible so that they can bend slightly while maintaining pressure on the module above, and to accommodate modules of various shapes.

In the preferred embodiment of FIG. 6 the pivoting end 17 of each locking arm is pivotally attached to a locking member 32, and not directly to the base, forming a pivoting bridge between and arm and the base. A locking member may be pivotally fixed between opposing prongs 39 projecting from the arm. The locking member is in turn pivotally attached to the base. The pivoting end of the arm and the pivot member pairing can collectively snap into a notch 35 in the side of the base to fix each locking arm 15 in a locked state projecting generally upwards and optionally radially outwards as well. The pivoting end of the arm and the pivot member can snap out of the notch to put the arm in an unlocked state. In the preferred embodiment the hook is first positioned over a locking surface 67 on the module above, and then the bottom pivoting end 17 of the arm 15 is pushed inward towards the notch 35 and snaps into place, pulling and holding the arm slightly downwards. This orientation creates tension on the locking arm 15 which pulls down on the module above to hold it in place. Slight flexing of the arms can also provide tension holding to secure a module.

The locking member 32 is preferably shaped so that the pivoting end 17 of the arm can rest either snapped fully into the notch or fully out of the notch, but is in a flexed and unstable conformation when the arm is only partially in the notch or just barely outside of the notch, so that some force is required to overcome tension to snap the arm into or out of the locked state. One way to accomplish this is shown in FIG. 6. The locking member 32 includes a semi-rigid flexing member 33. The flexing member is pivotally linked to the base by a base pivot 34, and pivotally linked to the pivoting end 17 of the arm 15 by an arm pivot 36. The flexing member is flexed and provides resistance as the bottom of the arm is pushed into or out of the notch 35 when the hook 25 is engaged to a locking surface 67, but is fully or partially relaxed when the bottom of the arm is pushed fully into the notch as shown in FIG. 1. The flexing member is also relaxed when the respective arm is in an unlocked position as shown in FIG. 6. This arrangement keeps the bottom pivoting end 17 of the locking arm 15 snapped into the notch 35, and the module held down onto the base, until a user deliberately pulls the bottom end 17 out of the notch, overcoming the tension, to release the locking arm.

It is preferred that the locking arrangement has the flexibility to lock the arms 15 at a range of angles to accommodate modules having different diameters. This can be achieved by flexibility in the locking arrangement, particularly the locking member 32 and its flexing member 33, by flexibility in the arms themselves, and/or by the pivoting connections between the base, locking member, and/or the arms. Locking arrangements other than the one described and depicted are within the scope of the invention. In alternative embodiments the locking arms are directly fixed to the base. In further alternative embodiments the arms 15 and/or the hooks 25 are fixed to the modules by a mechanism on the modules and/or on the distal end of the arms and downward tension if not required. Other mechanisms to “snap” or otherwise fix the pivoting end of the arm(s) into or onto the base are also within the scope of the intention.

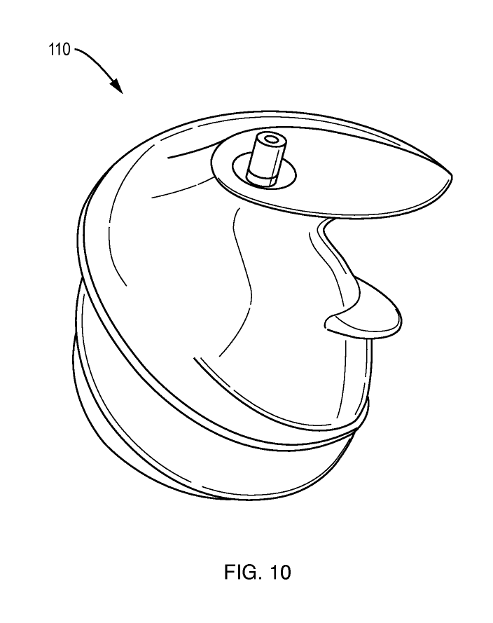

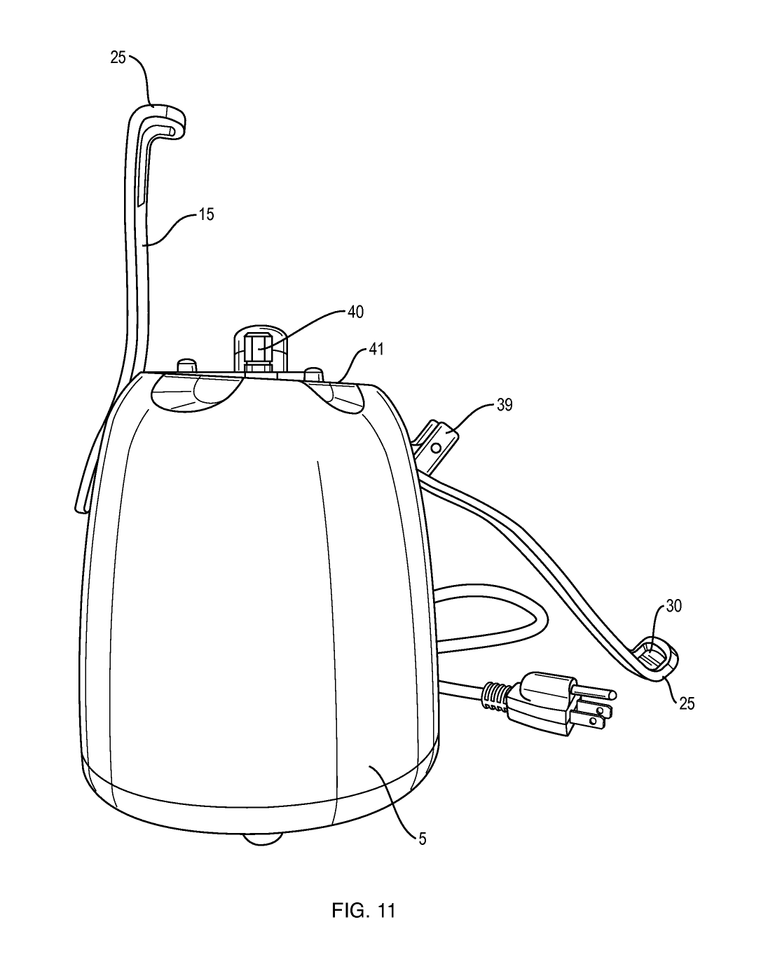

FIG. 11 depicts a rotatable drive shaft 40 projecting upwards from a top surface 41 of a base 5, the drive shaft being coupled to the motor inside the base and rotatable by the motor. A portion of the base handle is visible behind the drive shaft. In operation a module is seated on the top surface 41 in engagement with the drive shaft. A drive shaft projecting from the base is adapted to power different interchangeable modules using the same base. For example, in a preferred embodiment, the same base and drive shaft are used to power both a citrus juicer module and a slow juicer module. The drive shaft may be used to rotate a juicing member 75 in the form of a citrus reamer. Adapters 80 and extensions may be used to achieve compatibility between various modules and the drive shaft. Preferably the drive shaft 40 sits within an area of the top of the base which is shaped to hold the bottoms of juicer modules. The surface of the base and the bottom of various modules may optionally include complimentary sloping surfaces or interlocking voids and protrusions. Although a preferred embodiment resembling a small pitcher is depicted, the invention is not limited to a particular juice collector shape.

As mentioned, the instant system includes interchangeable modules for use with a singe base 1 which can all be held in place during use by the same set of easy-to-operate locking arms 15. The most preferred module, which is the non-limiting focus of this disclosure, is a citrus juice module for juicing halved citrus fruits.

The preferred citrus juice module 3 comprises a juice collector 45, a strainer 60, and a juicing member 75. The citrus juice module 3 is removably seated on top of the base 1 when in use, being held in place—in a locked citrus juicer state—by locking arms 15 as shown in FIGS. 1-2. When the arms are unlocked as in FIGS. 6, 8, and 11, the components of the citrus juicer module, when present, can all be lifted on and off the base 3 as a unit, preferably using a juice collector handle 50.

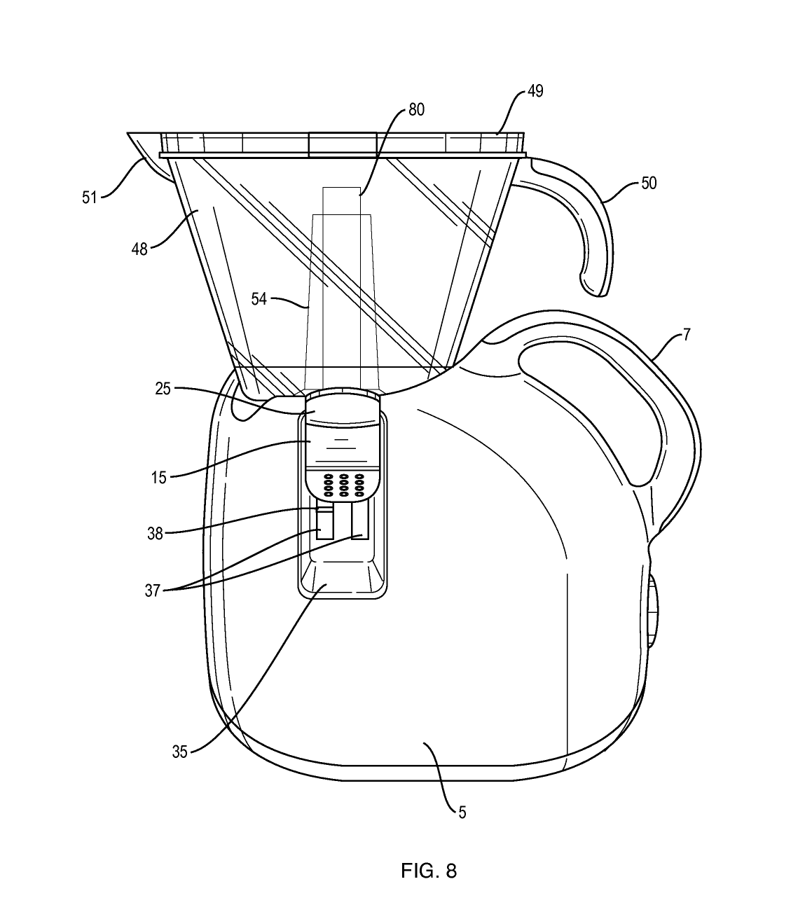

The structural heart of the citrus juice module is the juice collector 45, which in the preferred embodiment is seated directly on top of the base 1. The juice collector may be shaped like a small annular pitcher or measuring cup as shown in FIGS. 1, 3, and 8, although other shapes can be used. The preferred juice collector 45 has a floor 47, side walls 48 which are preferably circumferential, a lip 49 at the top of the side walls 48, an open top 55, a juice collector handle 50, and a spout 51 at the lip 49 for pouring juice which may be formed as part of the lip 49. There may be a hollow, upward facing sleeve 54 in the floor. The space or spaces where juice is collected and held are referred to as the juice collection area 52. The juice collection area 52 is typically bounded by the floor, the sleeve 54, and the side walls. In a preferred embodiment the radius of the juice collector generally increases moving upwards from the narrower floor 47 to the wider lip 49 at the top of the side walls 48, as best shown in FIG. 8. The floor 47 may be regular or irregular, may be sloped, and may be shaped to complement the top of the base 1 for increased stability.

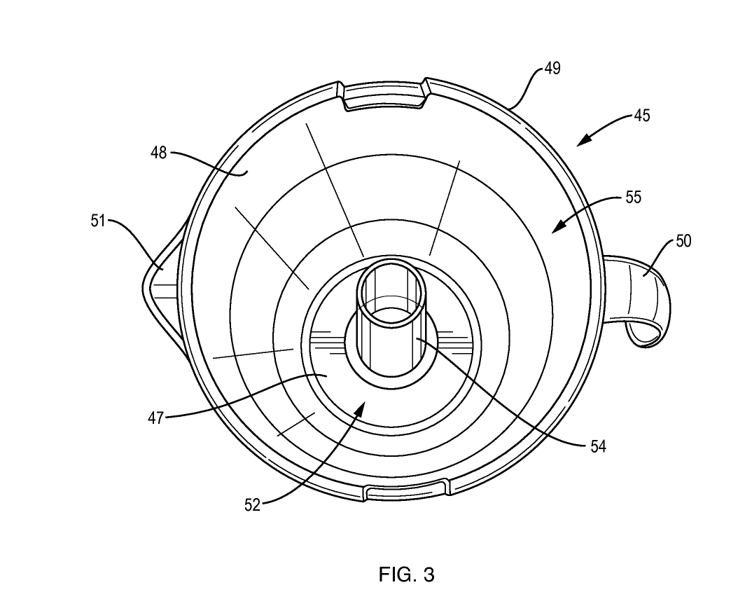

The juice collector preferably includes an axial sleeve 54 projecting upwards from the center of the floor 47 so that the drive shaft 40, adapter 80 (FIGS. 7 and 8), and other elements can traverse the juice collector without contacting juice. The sleeve may reach as high up as the lip 49, or it may be shorter or taller. The sleeve 54 may be a hollow chimney-like structure which is integral with the body of the juice collector 45 as shown in FIGS. 3 and 8. Preferably the sleeve is in the radial center of the juice collector 45, directly above the drive shaft and directly below the juicing member 75. The sleeve has walls which separate the area inside of the sleeve from the surrounding juice collection area 52. Preferably the sleeve has openings at the top and at the bottom, and provides a clear path axially through the center of the juice collector. Preferably the drive shaft 40 projects into a lower portion of the sleeve when the juice collector 45 is seated on the base 1.

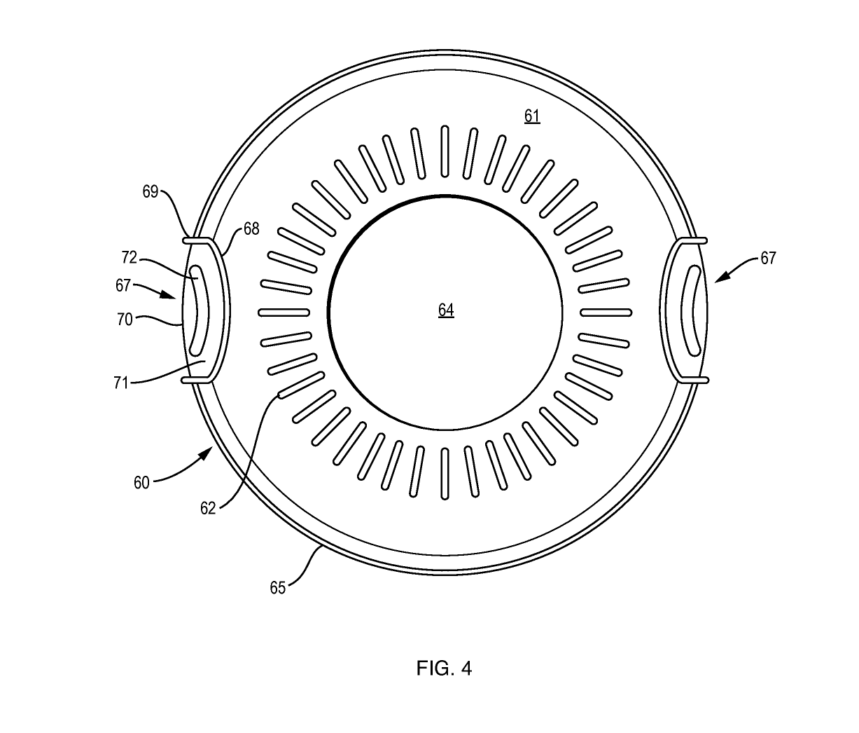

Referring to FIGS. 1-2 and 4, the strainer 60 can be removably seated on the lip 49 of the juice collector 45 and above the juice collection area 52. The strainer may sit entirely above the juice collector, or may partially or entirely sit below the lip of the juice collector. The strainer may be generally annular, and includes a strainer floor 61 with a plurality of apertures 62 spaced around the strainer floor 61 for passing citrus fruit juice while preventing or reducing the passage of seeds and pulp. A circular opening 64 is in the center of the floor 61 for accommodating the citrus juicing member 75 which may be a round, domed reamer. The Opening may have a similar size and shape as the juicing member, or it may be smaller. There is also a preferably circumferential strainer wall 65 surrounding the strainer floor to block fruit material from laterally leaving the strainer, and helping to channel juice towards the apertures 62. There may also be a lip or other structure to prevent juice from entering the circular opening 64 or getting under the juicing member 75 during use. The floor 61 is preferably shaped to channel juice to the apertures so that the apertures are at the lowest area or areas of the floor. The apertures can take a variety of shapes, such as round holes or the radial slots shown in FIG. 4.

The strainer can include locking surfaces 67, preferably at the top of the strainer wall 65, preferably at opposite sides of the strainer 60. The locking surfaces are each for releasably engaging a hook 25 at an end of a locking arm. In a preferred embodiment the strainer includes two opposite locking surfaces, but different numbers (such as one, three, or four) and different arrangements, with a corresponding number of locking arms 15 and hooks 25, are within the scope of the invention. In the depicted embodiment each locking surface 67 has an inner wall 68 and two side walls 69 shaped to be complimentary to the end of the hooks 65, and an open side 70 facing radially outwards for receiving a hook. Other shapes having more or fewer open sides are also possible. Each locking surface also has a floor 71. The locking surfaces preferably include one or more locking projections 72 protruding from the floor 71, the locking projection(s) 72 being shaped to fit inside of a locking cavity 30 under a hook 25. The protruding surfaces may be laterally elongated, arced structures as shown in FIG. 4, but other shapes and embodiments are possible. The projections should be shaped to help the hooks and/or the arms maintain a firmer grip on the locking surfaces.

The floors 71 of the locking surfaces may be horizontal and completely upwards-facing, or they may be at least partially sloped, such as being sloped at an angle downwards as they move radially outwards from the inner wall 68 towards the open side 70 at the edge of the locking surface. The slope and angle of locking surfaces can be varied between interchangeable modules so that modules having various shapes, sizes, and diameters can be used with the same base 5, hooks 25 and locking arms 15. For example, the arms 15 will be nearer to each other, in a more vertical position, for holding a module with a smaller diameter than a module with a greater diameter. In an embodiment where the hooks 25 are at a fixed angle (e.g. 90)°, the hooks will be in slightly different orientations, having different divergences from the horizontal, as the arms 15 pivot at different angles with regard to the base to accommodate modules having different diameters. Imagine, analogously, the upward-facing blade of a hockey stick which is at different angles as the handle of the hockey stick sweeps through an arc. Thus, it will often be desirable to orient the locking surfaces 67 at somewhat different angles based on the diameter of each module, and the corresponding angle that the locking arms 15 and their hooks 25 must be at to embrace the module. For example, the locking surfaces preferably tilt more for modules having greater diameters (where the locking arms must tilt outwards to reach opposite edges of the module) and are closer to horizontal or fully horizontal for modules with smaller diameters (where the locking arms can project essentially straight up).

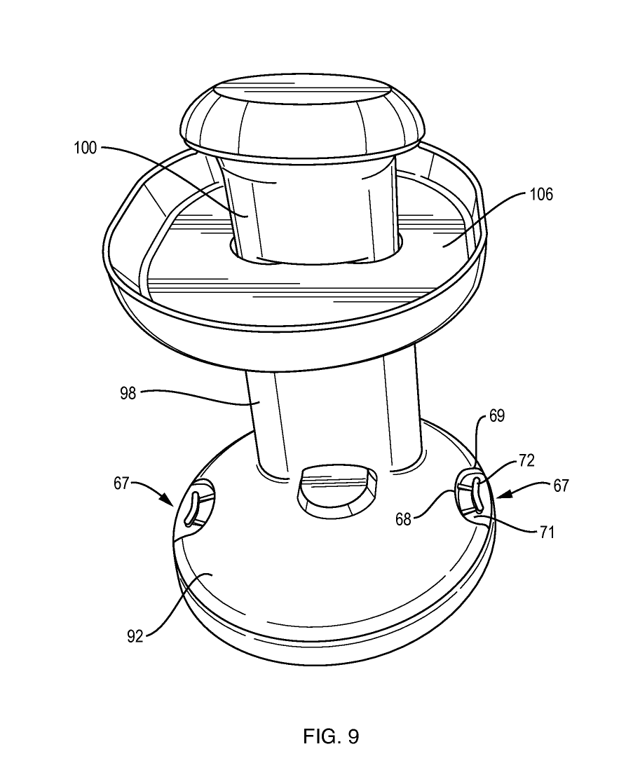

FIG. 9 is a lid 92 for a slow juicer module having similar locking surfaces 67 as those described above for use as part of an interchangeable slow juicer module 90. The lid may be positioned on a slow juicer collector 96 such as the one depicted in FIG. 6. The lid 92 includes two opposed locking surfaces 67 for fixing a slow juicer module to a base.

The citrus juicing member 75 (FIG. 5) is provided for reaming citrus fruits, and may resemble the ribbed, domed reamers used in traditional citrus juicers. The citrus juicing member 75 rotates, driven by the drive shaft below, to extract juice from halved citrus fruits held or pressed against it. In the preferred embodiment the member 75 rotates with respect to all or nearly all of the juicer 1, including rotating with respect to the strainer 60, although embodiments which include a rotating strainer are possible. Typically the juicing member is removably positioned in the center of the strainer 60 as shown in FIG. 2. The member 75 may be within a strainer opening 64, or may be just above a strainer opening.

The citrus juicing member is preferably directly above the drive shaft 40 which directly or indirectly turns the member when the juicer is activated. The juicing member 75 may be driveably engaged to the drive shaft 40 by a drive adapter 80 (FIG. 7) which is removably engaged to the drive shaft 40 at one end and to a bottom of the juicing member 75 at an opposite end. The depicted drive adapter is generally cylindrical, but other shapes are possible. The drive adapter 80 may be at least partially within the sleeve 54 of the juice collector 45 where it can traverse the juice collector 45 without contacting juice as shown in FIG. 8. The drive adapter can be used to span the distance between the drive shaft on the base, and the juicing member at the top of the juicer. Rotation of the drive shaft causes rotation of the drive adapter and, in turn, of the juicing member for removing juice from a halved citrus fruit. The drive adapter may include male or female surfaces at either end to engage complimentary male or female surfaces of the drive shaft and/or the juicing member 75. In one embodiment, the bottom of the drive adapter has a polygonal female opening at its bottom end to fit over a polygonal male portion of the drive shaft. In a related embodiment, the top of the drive adapter has a polygonal male portion for engaging a complimentary polygonal female attachment to the juicing member. Said polygons may be, for example, squares, hexagons, octagons, or star shapes. More than one adapter or other device may be used to bridge any gap between the drive shaft and the juicing member. The invention is not limited to any specific mechanism for driveably linking the drive shaft to the juicing member.

Drive adapters are another feature of the instant invention which allows the use of a variety of modules with a single base and motor. The base 5 of the depicted preferred embodiment includes a relatively short drive shaft 40. This short drive shaft is well suited for some modules, such as the preferred slow juicer module 90, but is far too short to directly rotate the citrus juicing member 75 of the citrus juice module 3 which may be positioned up on top of the juice collector, spaced away from the base. The drive adapter 80 makes it possible to use the same short drive shaft 40 to power both the citrus juicing member 75 and the slow juicer module.

FIG. 8 shows a base 5 having a pitcher-like juice collector 45 and a drive adapter 80 in place. The drive adapter is within the sleeve 54 and is engaged to the drive shaft below, which is not visible in this view. In this view the strainer 60 and the juicing member 75 of the citrus juice module are not in place and not depicted.

In FIG. 8 one locking arm 15 is visible, lifted at an intermediate angle pointing generally towards the viewer. Two parallel body slots 37 are within the notch 35, and are shaped and positioned to receive respective activation prongs 39 projecting from the bottom of the locking arm 15 when the arm is snapped into place is a locked configuration. Body slots or other analogous openings may be embodied as openings through the thickness of a plastic wall of the base into an interior area of the base. An activation surface 38, which may be a lever or switch in any shape, is located at or near one or more slots. Preferably the activations surface(s) are just inside the wall of the base near a slot 37. The activation surface is positioned so that it is contacted by an activation prong 39 when the respective arm bearing the prong is snapped into the notch. The action of prong(s) 39 passing through slot(s) 37 in the body and contacting activation surface(s) 38 inside the body may be used to control, limit, or permit activation of the motor. There may be two, four, or a different number of total body slots 37. Each body slot may lead to an activation surface, or there may be only one body slot in the base, or one body slot may be provided on each side of the base. In a preferred embodiment, there are two body slots 37 in each of two opposite notches on opposite sides of the base, and each of two arms has two activation prongs at or near its pivoting end 17. In a related preferred embodiment shown in FIGS. 1, 6, and 8, there is an activation surface just inside of a slot 37 on one or two sides of the juicer, and the motor is only able to run when the activation surface(s) are pushed inwards by a corresponding number of prong(s) 39 by snapping an arm into a locked state. In practice, two opposite arms 15 will be snapped into their respective slots 35 in a “locked” state, although in some embodiments there is only one activation surface, and only one arm actually trips the activation surface. In an alternative embodiment, snapping two opposed locking arms into respective notches simultaneously depresses activation surfaces positioned near each notch (allowing the motor to run) and, using the hooks at the opposite end of the arms, locks a juicer module in place on top of the base. These arrangements prevent the motor from running unless the juicer unit is properly locked into place in a “locked” state because the same snapping action that secures the module also presses the activation surface or surfaces, allowing the motor to operate.

Other similar arrangements are also possible using different numbers of prongs, slots, arms, and notches. The term “prong” should not be considered limiting of the overall invention—other shapes and projection types, or analogous arrangements lacking a projection, are within the scope of the invention. Alternative embodiments where activation surfaces project to or even outside of the surface of the base or notch to be contacted at or above the surface, such as button, lever, or switch-like arrangements, are also possible. Openings in the body which are not shaped as slots 37, and activation surfaces in various shapes, types, and positions, are within the scope and general inventive concept of the invention.

The juicer has a locked state and an unlocked state. The “locked” state generally refers to the state where an assembled module is seated on top of the base directly or indirectly engaged to the drive shaft, all of the arms are engaged to locking surfaces on the module, and the arms are fixed in a generally upwards position, such as by snapping the pivoting end 17 and pivot member 32 pairing into a notch 35 in the side of the base. Typically the “locked” state means that all of the arms are snapped into notches. A locked citrus juicer state simply means that the juicer is in a locked state with a citrus juice module 3 in place, as shown in FIGS. 1-2. Similarly, a locked slow juicing state means that the juicer is in a locked state with a slow juicer module in place instead of a citrus juicer module. Preferably, in locked states, one or more prongs of locking arms pass through slots in the notch and depress activation surfaces inside the base. In one embodiment two out of two activation surfaces must be simultaneously depressed towards the inside of the base for the juicer to be in an operable state. In another embodiment there are a plurality of sots and prongs, but only one activation surface. This preferably corresponds with a state where the module is locked into place by the hooks and prevents operating the device when the module is not properly fixed to the base.

The activation surface(s) may also be referred to as motor activation surfaces. In preferred embodiments, depressing an activation surface via locking the locking arm(s) is necessary but not on its own sufficient to activate the motor for juicing. In such embodiments, the activation surface(s) must be contacted while another control such as a switch, button, or knob is also in an activated state to activate the motor for juicing. This arrangement can be used to prevent accidentally activating the motor when the module is not assembled and fixed in place.

An “unlocked” state is any time the juicer is not in a locked state. For example, FIG. 6 shows a juicer in an unlocked state with both arms unlocked and splayed outwards. Typically in the unlocked state, at least one locking arm 15 is unlocked, the unlocked arm(s) are snapped out of their respective notches 35 in the body, the unlocked arms are disengaged from the locking surfaces 67 and locking projections 72 of the module, the locking arms are free to pivot outwards with respect to the body, and the locking arms do not hold the module 3 in place. If a module is in place the module can be freely lifted off of the base in the unlocked state, and the motor is in an inoperable state.

In a preferred embodiment the juicer will only operate when it is in a locked state, and will not operate when in an unlocked state. This may be accomplished by the use of a kill switch. In one embodiment the juicer will only operate when all the arms 15 are snapped on the notches, and when prongs on the arm depress one or more activation surfaces 38 through slits in the base body.

Preferably in the locked citrus juicer state, two locking arms hold the citrus juice module 3 in place on the base 1 for extracting citrus juice. See FIGS. 1 and 2. The arms can also help hold the components of the module in place, such as holding the strainer 60 down on top of the juice collector 45. Both locking arms 15 can be snapped into their respective notches 35 in the base 1 thereby fixing the locking arms 15 in place in an orientation exerting continuous downward pressure on the citrus juicer module 3 through the hooks 25. The hooks thereby fix the citrus juice module on the base, the locked locking arms 15 projecting generally upwards and also, optionally, somewhat radially outwards. The hook 25 of each locking arm is engaged to one of the two locking surfaces 67 on the strainer 60. The locking projection 72 of each locking surface 67 is inside of the concave locking cavity 30 under the corresponding locking arm 15 hook 25. The locking projection can be adapted to prevent the hooks and locking arms from slipping radially outwards and off of a module when the arms are under tension, such as when the pivoting end(s) of the arms are snapped into slots to lock the arms.

In a particularly preferred embodiment of the invention, the arrangement includes a base 5, a citrus juice module 3, and a slow juicer module 90 which is interchangeable with the citrus juice module. The juicer is adapted so that the citrus juice module and drive adapter can be removed from the base when the juicer is in the unlocked state. The slow juicer module 90 is adapted to be positioned on top of the base and in drivable engagement with the drive shaft, and may not require a drive adapter. See FIG. 6.

Other modules could also be used in place of or addition to these preferred examples using the same general system. Examples include a centrifugal juicer module, and masticating juicer module, a triturating juicer module, a food processing module, a mixer module, and/or a blender module.

In one embodiment a top portion 92 of the slow juicer module has a smaller radius than the strainer of the citrus juice module. A top portion of the slow juicer module, which may be a lid 92, has two opposite locking surfaces 67 which are preferably closer together than the locking surfaces of the citrus juice module. The slow juicer locking surfaces 67 therefore have floors 71 which are closer to horizontal and less inclined than the angled locking surface floors 71 of the citrus juice module 3, but which are otherwise substantially or entirely the same as the locking surfaces 67 of the citrus juice module 3. This arrangement is highly advantageous because it allows the same locking arms 15 and hooks 25 to hold either the citrus juice module or the slow juicer module even though the modules have different sizes and diameters. This principle—using the same or similar locking surface at varying angles and positions to accommodate different shape and sized modules with a single set of locking arms—can be generalized to other modules for use with the base.

In a locked slow juicing state, the two locking arms 15 hold the slow juicer module 90 in place on the base and in engagement with the drive shaft for extracting juice by slow juicing. Both locking arms 15 are snapped into their respective notches 35 in the base to fix the locking arms in place. The locked locking arms project generally upwards. In an embodiment where a slow juice module has a smaller diameter than an interchangeable citrus juice module, the arms are at an angle closer to vertical and are closer to each other than the locked locking arms in the locked citrus juicer state. The hook 25 of each locking arm is engaged to one of the two locking surfaces 67 on the slow juicing module, and the locking projection 72 of each locking surface of the slow juicing module is inside of the concave locking cavity 30 under the corresponding locking arm hook 25.

The apparatus in the locked citrus juicer state can be used in a conventional manner in which citrus fruits are cut in half and pressed on to the domed citrus juice extracting member 75 while the member 75 is rotated by the drive shaft 40 via a drive adapter 80. After juicing, the pivoting ends 17 of the arms 15 can be snapped out of the notches 35 to release the arms, and the hooks removed from the locking surfaces 67. The entire citrus juicing member including the collected juice can then be removed from the base as a unit, or alternatively as separate components. A user can then simply place the same or another module back onto the base, position the hooks at the locking surfaces, and snap the ends 17 of the arms 15 back into the notches to lock the module down in place for continued use.

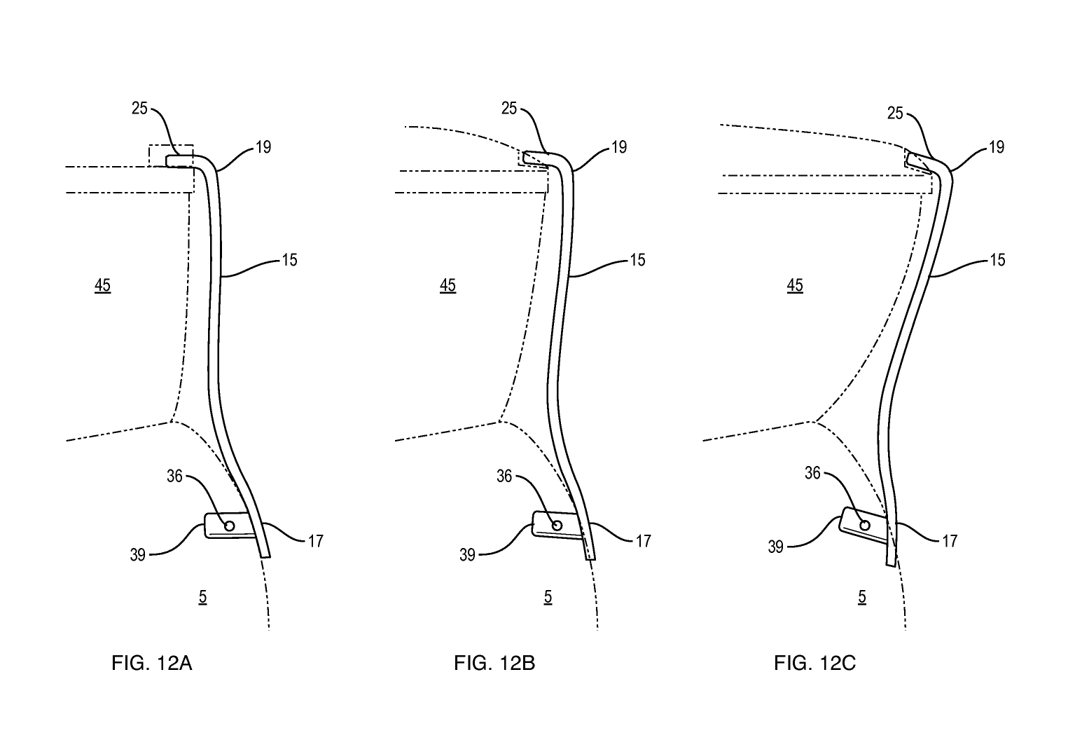

FIGS. 12a-12c help illustrate a particularly useful aspect of the invention: the ability to conveniently and interchangeably lock various modules of different sizes onto a single base 5 using the same pair of locking arms 15 with identical or similar locking surfaces 67 positioned at varying angles on the interchangeable modules. In FIG. 12a the module has a relatively small diameter, and as a result the arms 15 project straight up, and optionally slightly inwards, to hold the smaller module. In the depicted embodiment the locking surfaces on the smaller module are approximately horizontal, though embodiments where they tilt inwards or outwards are also possible. FIG. 12c, in contrast, shows a larger module with a greater diameter on the same base. To hold the larger module, the arms 15 are oriented further radially outwards than in 12a. In FIG. 12a the ends of the arms and the hooks will thus be closer to each other than in FIG. 12c, where the module has a greater diameter. To compensate for the arms flaring outwards, which changes the angles of the locking hooks 25, the locking surfaces 67 on the larger module slope downwards towards the outside of the module. FIG. 12b shows a medium sized module on the same base, where the positions of the arms 15 and the angles of the hooks 25 and locking surfaces are intermediate between 12a and 12c. In some embodiments, the arms are able to flex to help accommodate wider modules. In some embodiments a locking member 32 and/or a flexing member 33 of the locking member are flexible in a way that helps accommodate varying modules, while maintaining sufficient pressure to firmly hold the modules, by resiliently flexing to allow the arms to bend slightly away from the base.

Another way to describe an aspect of the system in that for wider modules the locking arms are positioned radially further outwards, while for smaller modules the locking arms are positioned radially further inwards. Another way to describe the same relationship is that the for narrower modules, the arms are positioned closer to a central axis of the base and closer to each other.

For larger modules, the locking surfaces will be sloped more towards the outside of the module, while for smaller modules the locking surfaces will be sloped more towards the inside of the module, which may be horizontal or, conceivably, slightly inwards. The slopes are preferably selected to compliment the angles of the bottom of the arms hooks when the arms are at various angles. Consider FIGS. 6 and 11, and the arc swept by the hooks 25 as the arms pivot up and down, as well as to orientation of the hooks 25 in FIGS. 12a-12c. The relative positions of the locking arms and locking surfaces for larger and smaller modules are conceived of in relative terms.

The apparatus may be made using molded plastic or other suitable materials. The juicer modules are preferably constructed to be readily dismantled for washing and storage, and are preferably dishwasher safe. Embodiments where the citrus juice module is embodied using more or fewer separate pieces are within the scope of the invention. For example, the different components of the citrus juicer module may or may not be provided as physically separate parts.

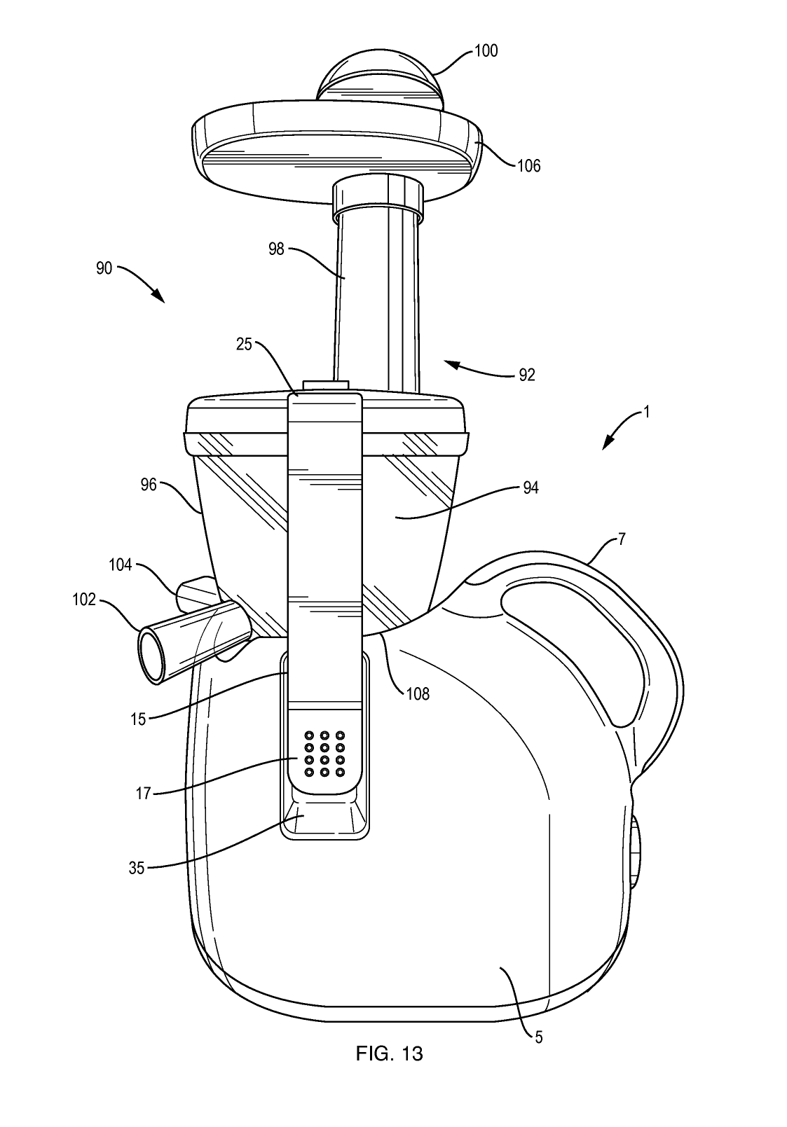

FIGS. 6, 9, 10, and 13 collectively show the components of a preferred slow juicer module 90. Slow juicers may be embodied including having a rotating screw or auger 110 which progressively presses fruit or other foods against a surrounding screen 94 to extract juice. Juice pressed through the screen can then collect in a receptacle such as the slow juicer collector 96 having a juice spout 102 and a pulp spout 104 shown in FIGS. 6 and 13. The slow juicer may include a removable top portion or lid 92 which preferably includes one or more locking surfaces 67, a hollow upward extension 98 for receiving fruit, a tray section 106 at the top of the upward extension 98 surrounding an opening for receiving fruit, and a plunger 100 for pushing fruit towards the slow juicing area into the opening for receiving fruit and through the upward extension. In use, the auger 110 is placed inside the screen 94 in engagement with the drive shaft protruding from the base below. A lid 92 is then placed on top of the slow juicer collector 96, and the slow juicer module 90 is secured in place using locking arms with the arm hooks 25 each engaged to a locking surface 67 on the lid 92. The juicer is finally put into a locked slow juicer state, and the slow juicer module is fixed to the base, when the bottom portions of the arm(s) are each snapped into notches in the base. A locked slow juicer state where the juicer is ready for operation—arms 15, 17 snapped into notches 35 and the slow juicer module 90 secured to the base 5 by the hooks 25— is shown in FIG. 13. The invention is not limited to a particular type of slow juicer.

Preferably the slow juicer module includes the same basic type and number of locking surfaces 67 as appear on the citrus juicing module. Referring to the slow juicer lid in FIG. 9, the most preferred locking surfaces for the slow juicer module also include an inner wall 68, side walls 69, an open side, a floor 71, and one or more locking projections 72. The floor 71 may be horizontal or slightly angled as necessary to accommodate the angle of the hooks 25 of the locking arms 15 when the juicer is in the locked slow juicer state. Preferably the locking surfaces of various modules for use with a given base are positioned along common arc corresponding to the positions that the hooks 25 of the locking arms 15 are able to move through when the arms are snapped into their respective notches.

A juicer system may comprise a plurality of modules, each of which has the same number of similar locking surfaces 67, which is equal to the number of locking arms 15 on the base 5. Each locking surface is preferably similar or identical within each system, though the angles of the locking surfaces may be varied to compensate for the different angles of the locking arms 15 and/or locking hooks 25 required for each module. Different locking surfaces than the ones specifically described here are within the scope of the invention, although it is preferred that modules each have the same number of locking surfaces, and that those locking surfaces can be used interchangeably with a single base and its arm(s) 15.

Preferably the juicer, and the motor and drive shaft of the juicer, are adapted to run at one or more speeds which are compatible for use with different types of modules. The motor may have only one speed or multiple speeds, and may include a reverse mode. In a preferred configuration the motor turns the drive shaft, a drive adapter, a citrus juicing member, a slow juicer, and/or other attachments, at between about 20 and 130 rotations per minute when in an unencumbered state, i.e. when fruit or other substances are not slowing rotation by providing substantial resistance. More preferably, the drive shaft and attachments are turned at from 30-120 RPM, from 40-100 RPM, from 50-90 RPM, 40-80 RPM, 50-80 RPM, 30-90 RPM, 30-80 RPM, or most preferably between 60-80 RPM. Resistance may slow the rotation in various modules, but the preferred speeds here refer to unencumbered speeds or speeds without excessive loading. In a preferred embodiment a single motor rotation speed is suitable for use with both slow juicing and citrus juicer attachments. Other types of juicers, in contrast, may run at much higher speeds which would not work well with citrus juicers.

In a preferred embodiment, the motor has a forward speed of about 67 RPM, a reverse direction, and an off position, all controlled by a single three position switch, and the motor and drive shaft will not turn in any direction unless the arms are snapped into their respective notches, and at least one activation surface is displaced inwards into the base by a prong.

It can be desirable to have a sloping floor 108 for the slow juicer module 90, typically a sloping floor of a slow juicer collector piece 96, so that juice will drain by gravity towards an opening for juice 102 at one side. This may make it desirable to have the top of the base 5 where the slow juicer module (and other modules) sit be similarly sloped. A slightly sloping top surface 41 of a base can be seen in FIG. 11. The top of the base 5 and the slow juice collector 96 slope slightly downwards moving from right to left in FIG. 13. As a result, it may also be desirable to provide a citrus juice module 3 with a similarly sloped floor so that both modules fit the same seat on the same base, and both are still at a generally horizontal orientation. This may be achieved by a juice collector having a sloped floor. The walls of the juice collector or other elements may be shaped to compensate for such sloping so that other parts of the module, such as the lip and/or the strainer, are substantially horizontal despite the sloping surfaces below. For example, the walls may be higher on one side of a juice collector to compensate for a being at a lower end of the floor.

The invention includes, separately and collectively, an improved citrus fruit juicer, a system of modular attachments each having similar locking surfaces for use with a single motorized base having locking arms which are complimentary to all of the locking surfaces, a system with interchangeable citrus juicer and slow juicer attachments for use with a single base, and a citrus juice extracting attachment for use with a motorized base. The invention also includes a method of fixing and releasing juicer modules from a single shared base comprising the use of locking arms at different angles, hooks, angled locking surfaces, notches, pivoting locking members, snapping locking arms into notches, and the other elements described in greater detail above. The invention also includes a method and apparatus for quickly locking and releasing module of different sizes and shapes on a single motorized base using locking arms and complimentary locking surfaces. The invention further includes a method and apparatus for selectively activating a motor only when locking arms are locked into place holding a module on top of a motorized base, automatically deactivating the motor when the arms are not locked, said system preferably using prongs to reversibly depress contact surfaces inside a base, and being usable with a variety of different modules. The various possible combinations of the features disclosed are all considered part of the invention.

The general concept of this invention is not limited to slow juicers or to citrus juicers, although the disclosed citrus juicer arrangement is believed to be novel and advantageous. The disclosed modular arrangement can be applied to various modules and combinations of modules other than the citrus modules and slow juicer modules specifically discussed. This includes both other types of juicer, and modules which are not juicers.

While specific embodiments of the invention has been shown and described in detail to illustrate the application of the principles of the invention, it will be understood that the invention may be embodied otherwise without departing from such principles.

What is claimed is:

1. A slow juicer and citrus juicer combination comprising a motorized base (5) and interchangeable citrus juice (3) and slow juicer (90) modules, the combination juicer comprising:
a base (5) containing a driving motor and a means for controlling the motor, and two elongated locking arms (15) projecting from opposite sides of the base (5);
wherein each locking arm (15) has a pivoting end (17) near the base and an opposite distal end (19) for holding modules, wherein each locking arm comprises a hook (25) at its distal end, each hook being a short end portion of an elongated locking arm (15) which is bent with regard to the adjoining section of the arm inward towards the juicer (1), each hook comprising a concave locking cavity (30) under the hook (25), each locking arm also comprising two prongs (39) projecting from the inner side;
wherein the prongs (39) at the pivoting end (17) of each locking arm are pivotally attached to a locking member (32) by an arm pivot (36), the locking member being in turn pivotally attached to the base by a base pivot (34), wherein a semi-rigid flexing member (33) of the locking member (32) spans between the base pivot (34) and the arm pivot (36), and wherein the pivoting end of each locking arm can snap into and out of a notch (35) in the base to respectively fix in place or release each locking arm (15), wherein each notch has two body slots (37) shaped to each receive a prong (39), wherein at least one activation surface (38) is provided within the base near at least one body slot (38), and wherein the flexing member (33) is adapted to provide resistance to snapping the pivoting end (17) into and out of the notch (35) when the hooks (25) are engaged to locking surfaces (67);
a rotatable drive shaft (40) projecting upwards from a top surface of the base, the drive shaft being coupled to the motor inside the base and rotatable by the motor;
the citrus juice module (3) comprising an annular juice collector (45), a strainer (60), and a juicing member (75), the citrus juice module being removably seated above the base (5) for extracting and collecting citrus juice;
the juice collector (45) being removably seated above the base (5), the juice collector being generally in the form of a small pitcher having a floor (47), circumferential side walls (48), a lip (49) at the top of the side walls (48), an open top (55), a juice collector handle (50), and a juice collection area (52) bounded by the floor and the side walls for collecting juice falling into the juice collector (45);
the juice collector further comprising an axial sleeve (54) projecting upwards from the center of the floor (47), the sleeve (54) being hollow and separating the surrounding juice collection area (52) from the inside of the sleeve, the drive shaft (40) projecting into a lower portion of the sleeve when the juice collector (45) is seated on the base (1);
the strainer (60) removably seated on the lip (49) of the juice collector (45) and above the juice collection area (52), the strainer being annular and comprising a strainer floor (61) with a plurality of apertures (62) spaced around the strainer floor (61) for passing citrus fruit juice while restraining the passage of seeds and pulp, an opening (64) in the center of the floor, and a circumferential strainer wall (65) surrounding the strainer floor and positioned to block fruit material from laterally leaving the strainer;
two locking surfaces (67) at opposite sides of the strainer (60) each for releasably engaging a hook (25) at an end of a locking arm, each locking surface (67) having an inner wall (68) and two side walls (69) shaped to be complimentary to the end of the hooks (65), and an open side (70) facing radially outwards for receiving a hook, each locking surface also having a floor (71) and a locking projection (72) protruding from the floor (71), the locking projection (72) being shaped to fit inside of a locking cavity (30) under a hook (25), wherein the floors (71) of the locking surfaces face at least partially upwards and also slope at an angle downwards as they move radially outwards towards the open side (70);
the citrus juicing member (75) for reaming citrus fruits being rotatable, and having a generally domed shape, the juicing member being positioned in the center of the strainer (60) and being at least one of within or above the opening (64) in the strainer floor (61) and being directly above the drive shaft (40);
wherein the juicing member (75) is driveably engaged to the drive shaft (40) by a drive adapter (80) which is removably engaged to the drive shaft (40) at one end and to a bottom of the citrus juicing member (75) at an opposite end, the drive adapter (80) being at least partially within the sleeve (54) of the juice collector (45) and spanning a distance between the drive shaft and the juicing member, wherein rotation of the drive shaft causes rotation of the drive adapter and of the juicing member for removing juice from a halved citrus fruit;
wherein the juicer has a locked citrus juicer state and an unlocked state;
wherein, in the locked citrus juicer state, the two locking arms hold the citrus juice module (3) in place on the base (1) for extracting citrus juice, both locking arms (15) are snapped into their respective notches (35) in the base (1) thereby fixing the locking arms (15) and hooks (25) in place, the hooks thereby fixing the citrus juice module on the base, the locked locking arms (15) projecting generally upwards and optionally radially outwards, the hook (25) of each locking arm is engaged to one of the two locking surfaces (67) on the strainer (60), the locking projection (72) of each locking surface (67) is inside of the concave locking cavity (30) under the corresponding locking arm (15) hook (25), the prongs (39) of the locking arms (15) are positioned in the body slots (38) in each notch (35), at least one prong (39) is contacting an activation surface (38) adjacent to a notch (35), and the motor is in an operable state;
wherein, in the unlocked state, the locking arms (15) are unlocked, the unlocked arms are snapped out of their respective notches (35) in the body, the unlocked arms are disengaged from the locking surfaces (67) and locking projections (72) of the strainer, the locking arms are free to pivot outwards with respect to the body, at least one activation surface (38) is not engaged by a prong (39), the motor is in an inoperable state, the locking arms do not hold the citrus juice module (3) or the slow juicer module (90) in place, the citrus juice module and the drive adapter (80), when present, can be removed from the base, and, when present, the slow juicer module (90) can be removed from the base;
the slow juicer and citrus juicer combination further comprising a slow juicer module (90) which is interchangeable with the citrus juice module (3) with respect to the base (1), the locking arms (15), and the drive shaft (40);
wherein the slow juicer module (90) is adapted to be positioned on top of the base and in drivable engagement with the drive shaft;
wherein a top portion of the slow juicer module has two opposite locking surfaces (67) which are closer together than the locking surfaces of the citrus juice module, and wherein the slow juicer module locking surfaces have floors (71) which face at least partially upwards and which are closer to horizontal than the angled locking surface floors (71) of the citrus juice module (3), but wherein the slow juicer module locking surfaces are shaped to be functionally interchangeable with the locking surfaces (67) of the citrus juice module (3);
wherein, in a locked slow juicing state, the two locking arms (15) hold the slow juicer module (90) in place on the base and in engagement with the drive shaft for extracting juice by slow juicing, both locking arms (15) are snapped into their respective notches (35) in the base to fix the locking arms in place, the locked locking arms projecting generally upwards at an angle so that the arms are closer to each other than the locked locking arms in the locked citrus juicer state, the hook (25) of each locking arm is engaged to one of the two locking surfaces (67) on the slow juicing module, a locking projection (72) of each locking surface of the slow juicing module is inside of the concave locking cavity (30) under the corresponding locking arm hook (25), at least one prong (39) is contacting an activation surface (38) adjacent to a notch (35), and the motor is in an operable state.

2. The slow juicer and citrus juicer combination of claim 1;
wherein the slow juicer module (90) comprises a juice spout (102) for juice exiting the module, and a floor of the slow juice module is sloped towards the juice spout to channel juice towards the juice spout;
wherein a top surface (41) of the base (5) is sloped to compensate for the sloped floor of the juicer module when the juicer module is seated on the base so that the juicer module as a whole is substantially level; and
wherein the floor (47) of the juice collector (45) of the citrus juice module (3) has substantially the same slope as the sloped floor of the slow juice module, the slope being adapted so that the citrus juice module as a whole is substantially level when seated on the sloped top surface of the base (5).

3. The slow juicer and citrus juicer combination of claim 1,
wherein the base comprises a handle (7) for holding and carrying the juicer; and
wherein the juice collector (45) of the citrus juice module (3) comprises a spout (51) at the lip (49) for pouring juice, and wherein the radius of the juice collector generally increases moving from the narrower floor (47) to the wider lip (49) at the top of the side walls (48).

4. The slow juicer and citrus juicer combination of claim 1,
wherein the locking arms (15) each comprise two parallel longitudinal ribs (22) on an inner side (24) of the locking arm which faces the base when the juicer is in a locked state, the ribs substantially tracing the perimeter of the locking arms (15);
wherein the longitudinal ribs (22) continue from the locking arms (15) into the hooks (25) and, at a far distal end of each locking arm, diverge from their parallel orientation towards each other to meet at the far distal end of the arm to form a locking rim (28) at the end (19) of the arm (15), wherein the ribs and the locking rim form the concave locking cavity (30) under each hook (25).

5. The slow juicer and citrus juicer combination of claim 1,
wherein the slow juicer module (90) comprises an annular slow juicer collector (96) for collecting juice, a screen (94) inside the slow juicer collector (96), and an auger (110) inside the screen (94) and engaged to the drive shaft (40) for rotation by the drive shaft.

6. The slow juicer and citrus juicer combination of claim 1, wherein the slow juicer module (90) comprises a lid (92) removably engaged to the top of the slow juicer collector (96), the lid (92) further comprising said two opposite locking surfaces (67) for fixing the slow juicer module (90) to the base (5).

7. The slow juicer and citrus juicer combination of claim 6,
wherein the slow juicer collector (96) comprises a juice spout (102) for juice exiting the slow juicer collector (96) and a pulp spout (104) for pulp exiting the slow juicer collector (96);
wherein the lid (92) comprises a hollow upward extension (98) for receiving fruit, the hollow upward extension providing a pathway between the outside of the slow juicer module (90) and an area encompassed by the screen (94); and
a plunger (100) shaped to at least partially fit within the hollow upward extension (98) for pressing fruit into the slow juicer module (90).

8. The slow juicer and citrus juicer combination of claim 1,
wherein the two locking surfaces on the citrus juice module are positioned at the top of the strainer wall (65); and
wherein the top portion (92) of the slow juicer module, which includes two locking surfaces, has a smaller diameter than the strainer wall of the citrus juice module where the citrus juice module locking surfaces are located.

9. A slow juicer and citrus juicer combination comprising:
a base (5) containing a driving motor with a drive shaft (40) projecting upwardly of the base, the drive shaft being rotatable by the motor;
at least one locking arm (15) having a lower end (17) pivotally connected to the base and an upper end with an locking hook (25) for engaging either a citrus juice module (3) or a slow juicer module (90) to lock the respective module to the base;
the slow juicer and citrus juicer combination comprising a citrus juice module (3) and a slow juicer module (90) which are interchangeable and which are both adapted for non-concurrent use with the base and the drive shaft;
the citrus juice module (3) comprising a citrus juice collector (45), a strainer (60) positioned over the citrus juice collector, and a juicing member (75) rotatable adjacent to the strainer for reaming citrus fruit, the citrus juice module being removably engaged on the base for extracting and collecting citrus juice, the citrus juice collector (45) having an outer side wall (48) and an inner hollow sleeve (54) defining an annular chamber there between, the citrus juice module being lockable to the base by the at least one locking arm (15), the drive shaft (40) being adjacent to or within a lower end of the hollow sleeve (54), the drive shaft (40) being driveably linked to the juicing member (75) for rotation of the juicing member (75) with operation of the motor to rotate the drive shaft when the citrus juice module (3) is engaged on the base;
the slow juicer module (90) comprising a slow juicer collector (96) for collecting juice, the slow juicer module being lockable to the base by the at least one locking arm (15), the slow juicer module further comprising a screen (94) within the slow juicer collector (96), a lid (92) connected to the slow juicer collector (96) above the screen, the lid having an opening into an area encompassed by the screen for passing fruit and vegetable pieces, and an auger (110) mounted for rotation in said area encompassed by screen, the auger having a lower end engaged to the drive shaft (40) for rotation of the auger (110) with operation of the motor to rotate the drive shaft when the slow juicer module (90) is engaged on the base,
the slow juicer and citrus juicer combination being adapted so that the slow juicer module (90) and the citrus juice module can both be removably and alternatively engaged on the base for extracting and collecting juice.

10. The slow juicer and citrus juicer combination of claim 9,
wherein the citrus juice module and the slow juicer module each include at least one locking surface (67) which is shaped for reversible engagement with a locking hook (25) of a locking arm (15) for reversibly fixing the modules to the base.

11. The slow juicer and citrus juicer combination of claim 10, wherein the locking surfaces on the citrus juice module and on the slow juicer module are substantially the same.

12. The slow juicer and citrus juicer combination of claim 10,
wherein the strainer (60) of the citrus juice module comprises two locking surfaces (67);
wherein the lid (92) of the slow juicer module comprises two locking surfaces; and
wherein there are two locking arms (15), and two locking hooks (25) which are engaged to the locking surfaces (67) when the respective modules are in use.

13. The slow juicer and citrus juicer combination of claim 10, wherein the locking surfaces face substantially upwards, and each comprises a floor (71) and at least one locking projection protruding from the floor (71);
wherein each locking hook (25) includes a concave locking cavity (30) which is shaped to fit over a locking projection (72); and
wherein a locking projection (72) is positioned within the locking cavity (30) of each hook (25) when a module is locked on the base (5).

14. The slow juicer and citrus juicer combination of claim 12, wherein the locking surfaces face substantially upwards, and each comprises a floor (71) and at least one locking projection protruding from the floor (71);
wherein each locking hook (25) includes a concave locking cavity (30) which is shaped to fit over a locking projection (72); and
wherein a locking projection (72) is positioned within the locking cavity (30) of each hook (25) when a module is locked on the base (5).

15. The slow juicer and citrus juicer combination of claim 10, wherein each module comprises a plurality of locking surfaces, the locking surfaces (67) face substantially upwards, and each locking surface comprises a floor (71) which is at least partially planar;
wherein the number of locking arms (15) and the number of locking hooks (25) is equal to the number of locking surfaces (67) on each respective module;
wherein the locking hooks (15) are at a substantially fixed angle with respect to the other portions of their respective locking arms (15);
wherein the locking surfaces of the citrus juice module are spaced further apart than the locking surfaces of the slow juicer module; and
wherein the planar portions of the locking surfaces (67) on the citrus juice module are tilted further towards the radial outside of the module than the planar portions of the locking surfaces (67) of the slow juicer module.

16. The slow juicer and citrus juicer combination of claim 15, wherein each locking surface comprises at least one locking projection (72) protruding from the floor (71) of the locking surface;
wherein each locking hook (25) includes a concave locking cavity (30) at a bottom surface of the hook which is shaped to fit over a locking projection (72); and
wherein a locking projection (72) is positioned within the locking cavity (30) of each hook (25) when a module is locked on the base (5).

17. The slow juicer and citrus juicer combination of claim 10, wherein one or more locking hooks (25) are offset by approximately 90° with respect to the other portions of the respective locking arms;
wherein the planar portions of the one or more locking surfaces (67) of the slow juicer module are substantially horizontal, and the planar portions of the one or more locking surfaces (67) of the citrus juicer module slope downwards towards the radial outside of the citrus juicer module; and
wherein the orientation of the planar surfaces of the respective modules substantially matches the orientation of a bottom surface of the locking hooks (25) which are engaged to the respective one or more locking surfaces (67) when the respective modules are locked to the base.

18. The slow juicer and citrus juicer combination of claim 17, wherein each locking surface comprises at least one locking projection (72) protruding from the floor (71) of the locking surface;
wherein each locking hook (25) includes a concave locking cavity (30) at a bottom surface of the hook which is shaped to fit over a locking projection (72); and
wherein a locking projection (72) is positioned within the locking cavity (30) of each hook (25) when a module is locked on the base (5).

19. The slow juicer and citrus juicer combination of claim 10,
wherein the base (5) comprises at least one notch (35) adjacent to the lower end (17) of each at least one locking arm (15);
wherein the lower end (17) of each at least one locking arm can snap into and out of a notch (35) in the base to respectively lock or release each locking arm (15);
the slow juicer and citrus juicer combination being adapted so that modules are fixed to the base via each at least one locking surface when each at least one locking arm (15) is locked by snapping each locking arm into a notch, and so that the modules are released from the base when each at least one locking arm is released from its notch.

20. The slow juicer and citrus juicer combination of claim 15,
wherein the base (5) comprises a notch (35) adjacent to the lower end (17) of each at least one locking arm (15);
wherein the lower end (17) of each at least one locking arm can snap into and out of a notch (35) in the base to respectively lock or release each locking arm (15);
the slow juicer and citrus juicer combination being adapted so that modules are fixed to the base for juicing when at least one locking surface (67) on the module is engaged to at least one hook (25), and when the locking arm (15) comprising said hook (25) is locked into a notch (35); and
the slow juicer and citrus juicer combination being further adapted so that modules, when present on the base, are released from the base when each at least one locking arm is unlocked by unlocking it from a notch.

21. The slow juicer and citrus juicer combination of claim 19,
wherein each locking arm comprises at least one prong (39) projecting from an inner side of the locking arm at the lower end (17) of the locking arm (15);
wherein each notch (35) comprises at least one body slot (37) opening into the base (5) and shaped to receive a prong (39) when the lower end of the respective locking arm (15) is snapped into that notch;
wherein at least one motor activation surface (38) is provided adjacent to at least one body slot (38);
wherein at lease one prong is positioned in a body slot (37) and contacting a motor activation surface (38), and the driving motor in an operable state, when each at least one locking arm (15) is snapped into a respective notch (35); and
wherein, when each at least one arm is not snapped into a notch, the prong or prongs do not contact the motor activation surface, and the driving motor is not in an operable state.

22. The slow juicer and citrus juicer combination of claim 21,
wherein there are two prongs (39) at the pivoting end (17) of each at least one locking arm, the prongs are pivotally attached to a locking member (32) by an arm pivot (36), the locking member being in turn pivotally attached to the base by a base pivot (34), wherein a semi-rigid flexing member (33) of the locking member (32) spans between the base pivot (34) and the arm pivot (36), and wherein the pivoting end of each locking arm can snap into and out of a notch (35) in the base to respectively fix in place or release each locking arm (15), wherein each notch has two body slots (37) shaped to each receive a prong (39), and wherein the flexing member (33) is adapted to provide resistance to snapping the lower end (17) of each at least one locking arm (15) into and out of a notch (35) when the hook (25) of that locking arm (15) is engaged to a locking surfaces (67).

23. The slow juicer and citrus juicer combination of claim 21, wherein each module comprises two locking surfaces (67), wherein there are two locking arms (15) each comprising a hook (25), and wherein there are two notches (35) on opposite sides of the base for snapping respecting locking arms (15) into and out of.

24. The slow juicer and citrus juicer combination of claim 9,
wherein the slow juicer module (90) comprises a juice spout (102) for juice exiting the module, and a floor of the slow juice module is sloped towards the juice spout to channel juice towards the juice spout;
wherein a top surface (41) of the base (5) is sloped to compensate for the sloped floor of the juicer module when the juicer module is seated on the base so that the juicer module as a whole is substantially level; and
wherein the floor (47) of the juice collector (45) of the citrus juice module (3) has substantially the same slope as the sloped floor of the slow juice module, the slope being adapted so that the citrus juice module as a whole is substantially level when seated on the sloped top surface of the base (5).

25. The slow juicer and citrus juicer combination of claim 12,
wherein the slow juicer module (90) comprises a juice spout (102) for juice exiting the module, and a floor of the slow juice module is sloped towards the juice spout to channel juice towards the juice spout;
wherein a top surface (41) of the base (5) is sloped to compensate for the sloped floor of the juicer module when the juicer module is seated on the base so that the juicer module as a whole is substantially level; and
wherein the floor (47) of the juice collector (45) of the citrus juice module (3) has substantially the same slope as the sloped floor of the slow juice module, the slope being adapted so that the citrus juice module as a whole is substantially level when seated on the sloped top surface of the base (5).

26. The slow juicer and citrus juicer combination of claim 10,
wherein the slow juicer and citrus juicer combination has a locked citrus juicer state, a locked slow juicer state, and an unlocked state;
wherein, in the locked citrus juicer state, two locking arms hold the citrus juice module (3) in place on the base (1) for extracting citrus juice, both locking arms (15) are snapped into respective notches (35) in the base (1) thereby fixing the locking arms (15) and hooks (25) in place, the hooks thereby fixing the citrus juice module on the base, the locked locking arms (15) projecting generally upwards and optionally radially outwards, the hook (25) of each locking arm is engaged to one of two locking surfaces (67) on the strainer (60), a locking projection (72) of each locking surface (67) is inside of a concave locking cavity (30) under the corresponding locking arm (15) hook (25), one or more prongs (39) projecting from the lower end of one or more of the locking arms (15) are positioned in one or more body slots (38) in one or more notches (35), at least one prong (39) is contacting an activation surface (38) adjacent to a notch (35), and the motor is in an operable state;
wherein, in a locked slow juicing state, the two locking arms (15) hold the slow juicer module (90) in place on the base and in engagement with the drive shaft for extracting juice by slow juicing, both locking arms (15) are snapped into their respective notches (35) in the base to fix the locking arms in place, the locked locking arms projecting generally upwards at an angle closer to each other than the locked locking arms in the locked citrus juicer state, the hook (25) of each locking arm is engaged to one of two locking surfaces (67) on the slow juicing module, a locking projection (72) of each locking surface of the slow juicing module is inside of the concave locking cavity (30) under the corresponding locking arm hook (25), one or more prongs (39) projecting from the lower end of one or more of the locking arms (15) are positioned in one or more body slots (38) in one or more notches (35), at least one prong (39) is contacting an activation surface (38) adjacent to a notch (35), and the motor is in an operable state; and
wherein, in the unlocked state, the locking arms (15) are unlocked, the unlocked arms are snapped out of their respective notches (35) in the body, the unlocked arms are not engaged to any locking surfaces (67) on a module, the locking arms are free to pivot outwards with respect to the body, at least one activation surface (38) is not engaged by a prong (39), the motor is in an inoperable state, and any module, if present, can be removed from the base.

27. The slow juicer and citrus juicer combination of claim 25, wherein the hooks (25) are spaced further from each other in the locked citrus juicer state than they are in the locked slow juicer state.

28. The slow juicer and citrus juicer combination of claim 10, wherein the locking surfaces (67) face substantially upwards;
wherein the quantity of locking arms (15) and the quantity of locking hooks (25) is equal to the quantity of locking surfaces (67) on each respective module, and to a quantity of notches (35) in the base;
wherein each at least one locking arm can be locked in an upward orientation where each locking hook (25) is engaged to a locking surface (67) on a module, and the lower end (17) of each locking arm is snapped into a notch (35);
wherein the locking hooks (15) are at a substantially fixed angle with respect to the other portions of their respective locking arms (15);
wherein the locking surfaces of the citrus juice module are spaced further apart than the locking surfaces of the slow juicer module; and
wherein the orientation of each at least one locking arm (15) is closer to a radial center of the arrangement when the slow juicer module (90) is locked in place than when the citrus juice module (3) is locked in place.

29. The slow juicer and citrus juicer combination of claim 9, wherein the motor is in an inoperative state when none of the at least one locking arms are locked onto a module.

30. The slow juicer and citrus juicer combination of claim 12, wherein the motor is in an inoperative state when none of the at least one locking arms are locked onto a module.

31. The slow juicer and citrus juicer combination of claim 13,
wherein each of the at least one locking arms (15) comprises two parallel longitudinal ribs (22) on an inner side (24) of the locking arm which faces the base when the locking arm is fixed to a module, the ribs substantially tracing the perimeter of the locking arms (15);
wherein the longitudinal ribs (22) continue from the locking arms (15) into the hooks (25) and, at a far distal end of each at least one locking arm, diverge from their parallel orientation towards each other to meet at the far distal end of the arm to form a locking rim (28) at the end (19) of the arm (15), wherein the ribs and the locking rim form the concave locking cavity (30) under each hook (25).

32. The slow juicer and citrus juicer combination of claim 12,
wherein the citrus juice module (3) comprises an elongated drive adapter (80) extending in the sleeve with a lower end engaged to the drive shaft (40) and an upper end engaged to the juicing member (75) for rotation of the juicing member (75) with operation of the motor to rotate the drive shaft when the citrus juice module (3) is engaged on the base.
